(19) United States
(12) Patent Application Publication
(10) Pub. No.: US 2018/0043903 A1
(43) Pub. Date: Feb. 15, 2018

(54) WIRELESSLY COMMUNICATING USER-CONTROLLED VEHICLE PREFERENCE SETTINGS WITH A REMOTE LOCATION

(71) Applicant: GM Global Technology Operations LLC, Detroit, MI (US)

(72) Inventors: Eric T. HOSEY, Royal Oak, MI (US); Russell A. PATENAUDE, Macomb Township, MI (US); Ryan M. EDWARDS, Macomb Township, MI (US)

(21) Appl. No.: 15/237,154

(22) Filed: Aug. 15, 2016

(51) Int. Cl. B60W 50/00; G06F 3/0484; B60W 50/08

(52) U.S. Cl. CPC B60W 50/0098; B60W 50/08; G06F 3/04847; H04L 67/12

(57) ABSTRACT

A system and method of communicating user-controlled vehicle settings with a remote location includes: detecting a change to one or more vehicle preference settings made by a vehicle user at a vehicle; wirelessly transmitting the vehicle preference setting(s) from the vehicle to a remote location; altering one or more default services provided to the vehicle user based on the change to the vehicle preference setting(s) made by the vehicle user; and providing the altered default service(s) to the vehicle user.

### TECHNICAL FIELD

The present invention relates to wireless communications and, more particularly, to wirelessly communicating user-controlled vehicle preference settings between a vehicle and a remote location.

### BACKGROUND

In the past, vehicles arrived from a manufacturing facility with an owner's manual and an expectation that the user will learn how to control the existing functionality of the vehicle. However, vehicles now offer ever-greater levels of customization that allow the user to modify vehicle functionality to suit their tastes and needs. For example, vehicles allow a user to select whether a vehicle display provides units in kilometers-per-hour (km/h) or miles-per-hour (mph). As the user drives the vehicle, the local speed limit signs printed in km/h or mph can be readily compared with the vehicle speed displayed in the vehicle for quick comparison. However, the user's selection affects only the systems in the vehicle and services provided from outside of the vehicle are unaware of the user's vehicle settings. Services provided to a vehicle from remote locations, such as a central facility or networked wireless device, may provide information in a format not consistent with the user's selected vehicle settings. For example, a central facility providing navigational directions to a user may provide those directions in mph despite a user's preference for km/h selected at the vehicle. It would be helpful to remotely provide services to the user in a format the user prefers.

### SUMMARY

According to an embodiment of the invention, there is provided a method of communicating user-controlled vehicle preference settings with a remote location. The method includes detecting a change to one or more vehicle preference settings made by a vehicle user at a vehicle; wirelessly transmitting the vehicle preference setting(s) from the vehicle to a remote location; altering one or more default services provided to the vehicle user based on the change to the vehicle preference setting(s) made by the vehicle user; and providing the altered default service(s) to the vehicle user.

According to another embodiment of the invention, there is provided a method of communicating user-controlled vehicle preference settings with a remote location. The method includes receiving, at a remote location, one or more vehicle preference settings that have been changed by a vehicle user; storing the changed vehicle preference setting(s) at the remote location; altering one or more default services provided to the vehicle user from the remote location based on the change to the vehicle preference setting(s) made by the vehicle user; and providing the altered service(s) to the vehicle user.

According to yet another embodiment of the invention, there is provided a method of communicating user-controlled vehicle preference settings with a remote location. The method includes detecting a change to a language setting or a location setting made by a vehicle user; wirelessly transmitting the changed language setting or the location setting from the vehicle to a remote location; altering one or more services provided to the vehicle user based on the language setting or the location setting; and providing the altered service(s) to the vehicle user.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow chart depicting an embodiment of a method of communicating user-controlled vehicle preference settings with a remote location.

### DETAILED DESCRIPTION OF THE ILLUSTRATED EMBODIMENT(S)

The system and method described below detects changes made to vehicle preference settings by a vehicle user and wirelessly transmits those preference settings to a remote location. Those settings are then used to alter default services provided to the vehicle user—either inside of the vehicle or elsewhere.

Vehicle preference settings are aspects of the vehicle configured based on the choices of the vehicle user. The vehicle preference settings can include the language the vehicle user speaks or wants the vehicle to use, an identification of a country in which the vehicle is used/located, or an identification of the measurement units (e.g., km/h) preferred by the user or vehicle user, to provide a few examples. When a vehicle is manufactured, it may include default vehicle preference settings that the manufacturer can establish based on the location where the vehicle will be sold. For example, vehicles sold in the United States may include default vehicle preference settings that include English as a default language and miles as the default units for distance. But vehicles can be configured to use languages other than English and to display distance in kilometers. The vehicle can detect when the vehicle user changes the default vehicle preference settings and then wireless transmits the changed vehicle preference settings to a remote location.

Once a vehicle user changes one or more vehicle preference settings, these changes can be wirelessly sent to a remote location that provides one or more services to the vehicle. For example, the vehicle can send the changed vehicle preference settings to a remote location that provides vehicle telematics services to the vehicle, such as a back-office computer or a call center, or a handheld wireless device that communicates with the vehicle. The remote location may be set up to provide services using default settings, such as miles for distance and mph for speed. But after the remote location receives vehicle preference settings that have been changed to indicate km or km/h is preferred, the remote location can store the changed vehicle preference settings with a unique identifier and modify at least some of the default settings the remote location uses to provide default services. The vehicle can automatically transmit the changed vehicle preference settings to remote locations, which then use those vehicle preference settings to provide services to the vehicle user.

### Communications System—

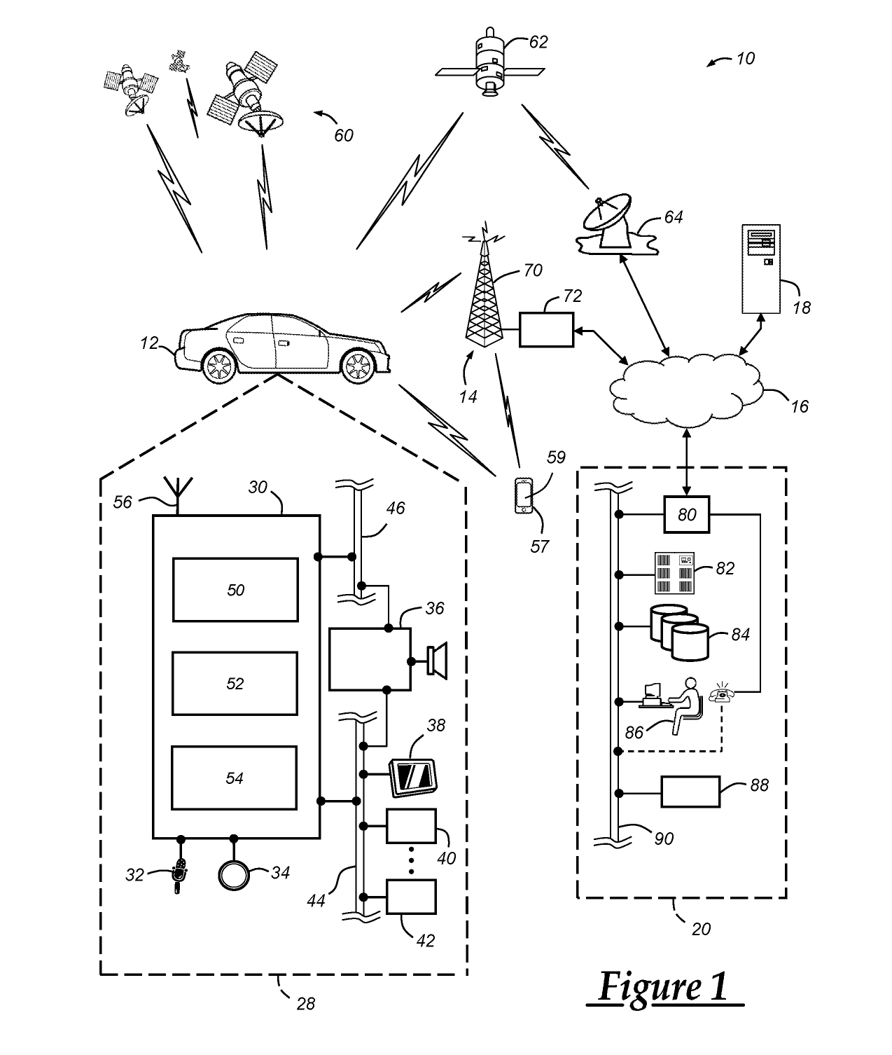

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of other vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is itself a vehicle system module (VSM) and can be implemented as an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™ Wi-Fi direct, Bluetooth™, or near field communication (NFC). When used for packet-switched data communication such as TCP/IP, the telematics unit can be configured with a static IP address or can be set up to automatically receive an assigned IP address from another device on the network such as a router or from a network address server.

One of the networked devices that can communicate with the telematics unit 30 is a handheld wireless device, such as a smart phone 57. The smart phone 57 can include computer processing capability, a transceiver capable of communicating using a short-range wireless protocol, and a visual smart phone display 59. In some implementations, the smart phone display 59 also includes a touch-screen graphical user interface. The smart phone 57 can also include a GPS module capable of receiving GPS satellite signals and generating GPS coordinates based on those signals. The smart phone 57 also includes one or more microprocessors that execute machine code to generate logical output. Examples of the smart phone 57 include the iPhone manufactured by Apple and the Galaxy manufactured by Samsung, as well as others. While the smart phone 57 may include the ability to communicate via cellular communications using the wireless carrier system 14, this is not always the case. For instance, Apple manufactures devices such as the various models of the iPad and iPod Touch that include the processing capability, the display 59, and the ability to communicate over a short-range wireless communication link. However, the iPod Touch™ and some iPads™ do not have cellular communication capabilities. Handheld wireless devices can also be implemented as keyfobs that are used with keyless vehicle entry systems. Passive entry passive start (PEPS) systems employ a keyfob that permits the vehicle user to access and operate the vehicle 12 based on keyfob presence. The keyfob communicates wirelessly with the VSM 42 to control access to the vehicle 12. These and other similar devices may be used or considered a type of handheld wireless device for the purposes of the method described herein.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the telematics unit 30, audio system 36, and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbutton(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method—

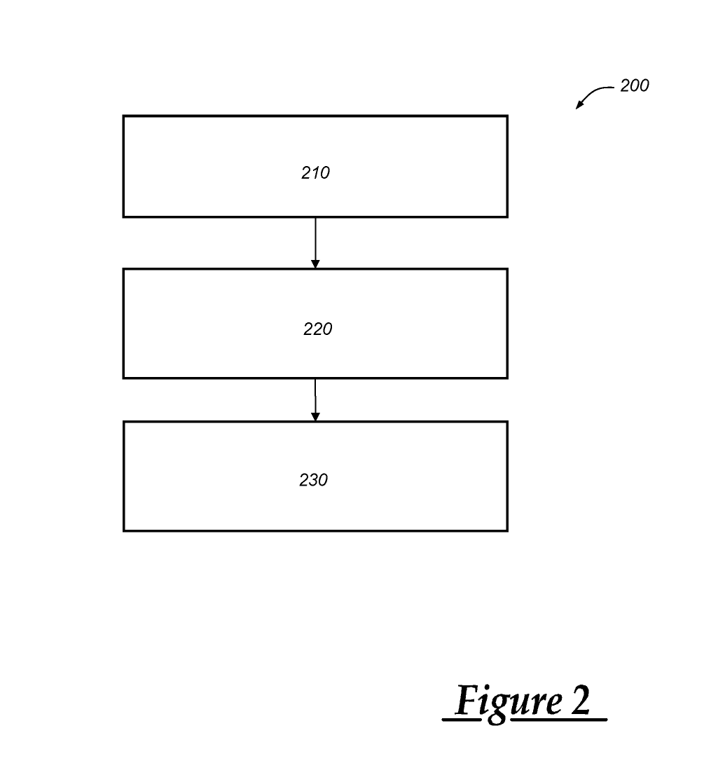

Turning now to FIG. 2, there is shown a method (200) of communicating user-controlled vehicle preference settings with a remote location. The method 200 begins at step 210 by detecting a change to one or more vehicle preference settings made by a vehicle user at the vehicle 12. Vehicle preference settings include the language the vehicle user speaks or wants the vehicle 12 to use for providing the vehicle user information, an identification of a country in which the vehicle 12 is used or located, or an identification of the measurement units (e.g., kilometers and km/h) preferred by the vehicle user. These are just a few examples and it should be appreciated that others vehicle preference settings exist. The vehicle 12 may be configured using one or a plurality of different vehicle preference settings. The vehicle user can direct the vehicle 12 to display one or more menus that include vehicle preference setting selections shown on the visual display 38 and choose one of the selections using a touch screen or other peripheral input device that is known to those skilled in the art. For example, the vehicle user can be offered a menu of language options available at the vehicle 12 with the currently-selected language identified. The vehicle user can then scan the language options available on the menu and change the language used at the vehicle 12 if desired. The visual display 38 can then display text to the vehicle user in the language selected by the vehicle user.

In another example, the selected vehicle preferences can be applied to the audio system 36. The vehicle 12 can present a list of radio stations the audio system 36 provides on the visual display 38. Each of the radio stations can be identified as broadcasting in a particular language. After receiving one or more radio station selections from the vehicle user, the processor 52 of the vehicle telematics unit 30 can identify the languages of radio station selections and set a language preference based on these selections. For example, if more than 65% of the language identifiers associated with the selected radio stations belong to a common language, the vehicle telematics unit 30 can establish that language as a vehicle preference setting selection.

Language is just one of many possible vehicle preference settings. Units of measure are another vehicle preference setting that can be configured by the vehicle user. The vehicle user can access a menu shown on the visual display 38 that indicates whether the vehicle 12 will display information using the U.S. system, which uses miles, mph, Fahrenheit, quarts, and gallons, or the metric system which uses kilometers, km/h, Celsius, and liters. The vehicle user can also identify the vehicle location as part of vehicle preference settings. For example, the vehicle 12 may have been configured for delivery in North America and the vehicle user can specify the country in North America where the vehicle 12 is used. The identified country can be used to establish or change vehicle functions at the vehicle 12. This will be discussed in more detail below. The vehicle preference setting(s) can be stored at the vehicle 12. The method 200 proceeds to step 220.

At step 220, the vehicle preference setting(s) are wirelessly transmitted from the vehicle 12 to a remote location. The remote location receives the vehicle preference settings that have been changed by a vehicle user at the vehicle 12. The remote location can be a remote facility, such as the computer 18 or the call center 20. After the vehicle user changes one or more vehicle preference settings, the vehicle 12 can detect the changes and wirelessly send the vehicle preference settings to the remote facility. The processor 52 of the vehicle telematics unit 30 can detect the receipt of vehicle preference settings input by the vehicle user using the button 34 and visual display 38. The processor 52 can receive the vehicle preference settings over the communications bus 44 and compare the vehicle preference settings with vehicle preference settings previously-stored in the memory devices 54. The processor 52 can determine whether the received vehicle preference settings differ from the previously-stored vehicle preference settings and update the stored vehicle preference settings with any changes.

The vehicle telematics unit 30 can also decide when to wirelessly transmit the vehicle preference settings to the remote facility. The vehicle preference settings can be wirelessly sent to the computer 18 or the call center 20 via the wireless carrier system 14 as soon as the vehicle telematics unit 30 detects a change in those settings. It is also possible for the vehicle telematics unit 30 to delay sending the changed vehicle preference settings. For example, the vehicle telematics unit 30 can detect a change to the vehicle preference settings yet wait until the vehicle 12 receives a call initiated from the remote facility and, as part of the call, wirelessly transmit the changed vehicle preference settings to the remote facility. Or the vehicle telematics unit 30 can periodically send vehicle preference settings to the remote facility. This can economize the use of cellular communications airtime.

It should be appreciated that vehicle preference settings can be received at wireless devices other than the vehicle telematics unit 30. For example, handheld wireless devices such as the smart phone 57 can receive vehicle preference settings. The smart phone 57 can be carried by the vehicle user and used to make telephone calls as well as access information from the Internet via the wireless carrier system 14 or a Wi-Fi hotspot. The use of the smart phone 57 can reveal choices made by a vehicle user that may be used to change vehicle preference settings. In one example, the vehicle user may request navigational directions using the smart phone 57. The vehicle user can provide a location to the smart phone 57 and receive directions from an Internet-based service provider, such as Google Maps. The vehicle telematics unit 30 can periodically query the smart phone 57 using short-range wireless communication protocols and request selections made by the vehicle user, such as locations or language selections, and the smart phone 57 can wirelessly communicate those selections to the vehicle telematics unit 30. Apart from or in addition to using short-range wireless communications techniques, the vehicle telematics unit 30 could communicate with the smart phone 57 through a remote facility, such as the computer 18 or the call center 20. Or the smart phone 57 can provide the vehicle preference settings directly to the remote facility. The remote facility can identify the vehicle preference settings using a unique identifier, such as a vehicle identification number (VIN), a mobile equipment identifier (MEID), or a customer account number that the remote facility can associate with a particular vehicle user.

Vehicle preference settings can be associated with a handheld wireless device and when the vehicle telematics unit 30 detects the presence of the handheld wireless device, the vehicle telematics unit 30 can begin using those vehicle preference settings. As the vehicle user approaches the vehicle 12 with a handheld wireless device, the vehicle telematics unit 30 can receive an identifier from the device via a short-range wireless communications communication link. If the handheld wireless device is the smart phone 57, the identifier can be an MEID but if the handheld wireless device is a keyfob it can transmit a unique identifying code. The vehicle telematics unit 30 can use the identifier to determine the identity of the handheld wireless device and access vehicle preference settings associated with that device. The vehicle preference settings can be stored locally at the vehicle 12 or the vehicle telematics unit 30 can send the handheld wireless device identifier to the remote facility with a request for vehicle preference settings associated with the handheld wireless device identifier. The remote facility can access a database that includes vehicle user identifiers that have been associated with handheld wireless device identifiers and vehicle preference settings that can be individually associated with a particular handheld wireless device identifier. The handheld wireless device identifiers received at the remote facility with the request can be used to search for vehicle preference settings associated with a particular wireless handheld device. When the received handheld wireless device identifier is found, the vehicle preference settings associated with the handheld wireless device can be sent to the vehicle 12.

In this way, user settings may be propagated from the device where they were initially entered/selected by the user to other devices and systems that change user settings to provide improved services for the user. As noted above, this may involve sending the vehicle preference settings to a back-office server or other remote facility. Alternatively or additionally, the settings may by propagated within the vehicle itself. For example, a vehicle preference setting of km/h selected by the user for the speedometer display may be transmitted to the telematics unit 30 or to a dedicated navigational system to thereafter display all driving directions and other data on the telematics/navigational display (e.g., display 38) in km units rather than miles. As another example, a language selection through the radio (audio system 36) settings or via the general vehicle settings may be transmitted within the vehicle to other VSMs that present text and/or speech. The setting may then be used by those VSMs to present content in the chosen language. When done through the radio settings, this language selection may be explicit, such as by the user manually selecting a desired language preference setting, or implicitly such as in response to a user selection of a majority of foreign language radio stations as their preset stations. The method 200 proceeds to step 230.

At step 230, one or more default services provided to the vehicle user are altered based on the change to the vehicle preference setting(s) made by the vehicle user and those services are provided to the vehicle user. A wide variety of different services can be provided to vehicle users. These services include navigational directions provided by the call center 20 as well as vehicle data delivery to the vehicle user. Providing these services to the vehicle user may involve some default settings that have been established to please the largest number of vehicle users. For example, with respect to navigational directions, the call center 20 may be configured to communicate with vehicle users in English and provide navigational directions in miles and mph. However, altering these default settings for individual vehicle users based on vehicle user preference can increase the number of users who are satisfied with the service. In this example, the call center 20 can identify the vehicle user who calls by the VIN, MEID, or customer account number and access the vehicle preference selections associated with that vehicle user. The call center 20 can compare the default settings—in this case the English language and miles for distance measurements—with the vehicle preference selections. If the vehicle preference selections indicate that the vehicle user prefers Spanish and has previously set the vehicle 12 to display distances in kilometers, the call center 20 can alter the default settings to provide navigational directions in Spanish and distances in kilometers. The call from the vehicle user to the call center 20 can be routed within the call center to a live advisor 86 who speaks Spanish.

Apart from the call between the call center 20 and the vehicle user, the vehicle preference settings can also be used for other communications with the vehicle user. For example, the computer 18 may construct email messages that include vehicle data remotely obtained from the vehicle telematics unit 30. The computer 18 or call center 20 can remotely request and receive vehicle data from one or more vehicles and build email messages for those vehicles that include the received data. Each email can identify one or more vehicles owned or regularly used by a particular vehicle user and include vehicle data for each vehicle. The vehicle data can indicate whether vehicle service is necessary, such as tire pressures falling below acceptable levels or upcoming oil change needs. The vehicle data can also indicate any diagnostic trouble codes or vehicle recall information. These emails may be sent from the computer 18 or call center using default settings, such as they can be written in English and include units based in miles. However, for each vehicle user or email, the computer 18 can access the vehicle user associated with the email and determine if the vehicle preference settings are different than the default settings used to send the email. For instance, if the vehicle preference settings include Spanish for a language and kilometers for distance, the email can be constructed so that the units such as vehicle mileage are in kilometers and the email is written in Spanish.

The vehicle preference selections can be used to set up configurable vehicle instructions provided at the vehicle 12. Vehicles can be delivered to different geographical regions and depending on the identity of the geographical region where the vehicle operates provide different vehicle instructions to the driver. For example, in the United States speed limits rarely exceed 80 mph but in other countries it is not unheard of for vehicles to regularly be allowed to travel at speeds of 100 mph or higher. The different speed limits can change vehicle instructions provided to a vehicle user. For example, vehicles can include instructions for levels of tire pressure used at various speeds, loads, or both. In the past, these tire pressure levels were commonly shown on a tire information placard applied to the B-pillar of the vehicle 12. However, the information included on the tire information placard may now be shown on the visual display 38. The vehicle instructions in the form of tire pressure values shown on the visual display 38 can be altered based on vehicle location. In one example, the tire pressure values can be shown in kilopascals (kPa) rather than pounds-per-square inch (psi) when the vehicle preference settings indicate that the selected location is Germany rather than England. The tire pressure values can also be increased for German locations relative to English locations to compensate for higher vehicle speeds. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of communicating user-controlled vehicle preference settings with a remote location, comprising the steps of:
(a) detecting a change to one or more vehicle preference settings made by a vehicle user at a vehicle;
(b) wirelessly transmitting the vehicle preference setting(s) from the vehicle to a remote location;
(c) altering one or more default services provided to the vehicle user based on the change to the vehicle preference setting(s) made by the vehicle user; and
(d) providing the altered default service(s) to the vehicle user.

2. The method of claim 1, wherein step (a) comprises detecting the change using a vehicle telematics unit.

3. The method of claim 1, wherein step (a) comprises detecting the change at a handheld wireless device.

4. The method of claim 1, wherein the remote location comprises a vehicle telematics unit.

5. The method of claim 1, wherein the remote location comprises a remote facility.

5. The method of claim 1, wherein the altered default services comprise sending an email that includes vehicle data to the vehicle user.

6. The method of claim 1, further comprising the step of detecting a handheld wireless device at the vehicle and selecting one or more vehicle preference settings based on the identity of the handheld wireless device.

7. The method of claim 1, wherein the default service comprises a vehicle instruction.

8. A method of communicating user-controlled vehicle preference settings with a remote location, comprising the steps of:
(a) receiving, at a remote facility, one or more vehicle preference settings that have been changed by a vehicle user;
(b) storing the changed vehicle preference setting(s) at the remote facility;
(c) altering one or more default services provided to the vehicle user from the remote facility based on the change to the vehicle preference setting(s) made by the vehicle user; and
(d) providing the altered service(s) to the vehicle user.

9. The method of claim 8, wherein the vehicle preference settings are detected using a vehicle telematics unit.

10. The method of claim 8, wherein the vehicle preference settings are detected using a handheld wireless device.

11. The method of claim 8, wherein the altered default services comprise sending an email that includes vehicle data to the vehicle user.

12. The method of claim 8, further comprising the steps of receiving a handheld wireless device identity, selecting one or more vehicle preference settings based on the identity of the handheld wireless device, and transmitting the vehicle preference setting(s) to the vehicle.

13. The method of claim 1, wherein the default service comprises a vehicle instruction.

14. A method of communicating user-controlled vehicle preference settings with a remote location, comprising the steps of:
(a) detecting a change to a language setting or a location setting made by a vehicle user at a vehicle;
(b) wirelessly transmitting the changed language setting or the location setting from the vehicle to a remote location;
(c) altering one or more default services provided to the vehicle user based on the language setting or the location setting; and
(d) providing the altered default service(s) to the vehicle user.

15. The method of claim 14, wherein step (a) comprises detecting the change using a vehicle telematics unit.

16. The method of claim 14, wherein step (a) comprises detecting the change at a handheld wireless device.

17. The method of claim 14, wherein the remote location comprises a vehicle telematics unit.

18. The method of claim 14, wherein the remote location comprises a remote facility.

19. The method of claim 14, further comprising the step of detecting a handheld wireless device at the vehicle and selecting one or more vehicle preference settings based on the identity of the handheld wireless device.

20. The method of claim 14, wherein the default service comprises a vehicle instruction.
